(19) United States
(12) Patent Application Publication
(10) Pub. No.: US 2006/0053033 A1
(43) Pub. Date: Mar. 9, 2006

(54) Method and system for managing a membership based health care program not utilizing primary care insurance

(76) Inventor: Victor Wood, Wheeling, WV (US)

Correspondence Address: HARSHAW RESEARCH INCORPORATED, P O BOX 418, OTTAWA, KS, 66067, US

(21) Appl. No.: 10/927,877

(22) Filed: Aug. 27, 2004

(51) Int. Cl. G06Q 50/00

(52) U.S. Cl. 705/2; 705/4

(57) ABSTRACT

A system and method for managing an electronically-implemented membership based health care program without utilizing primary care medical insurance includes providing a health clinic having doctors to provide medical services to its members. An electronic database which may be connected to computer network manages member records, including a purchase arrangement by which services may be obtained. Enrolled members in good payment standing may receive primary care medical services from the clinic, including unlimited office visits. Clinic employees receive the medical services as an employee benefit. The clinic may be owned by another company not related to health care and having employees who also receive the medical services, the company paying the clinic according to the purchase arrangement. Neither the clinic nor its members utilize primary care insurance. The method results in dramatically decreased healthcare costs and higher effective employee compensation.

### BACKGROUND OF THE INVENTION

This invention relates generally to methods of administering healthcare and, more particularly, to an electronically-implemented business method and system for managing a membership based healthcare program that does not utilize or involve primary care health insurance.

The high cost, inefficiency, and bureaucracy of medical insurance has overwhelmed both patients and physicians. Many doctors complain that too large a portion of their time is spent filing and managing insurance claims and that honoring the large number of insurers for their patients adds significantly to the overhead cost of their practice. Consequently, much of this cost gets passed along to their patients, increasing the cost of healthcare and further frustrating everyone concerned.

Various proposals have been made, in both the public and private sectors, to streamline the health care system and to hold down the rising costs. However, efforts to shore up a broken system founded on primary care insurance have not been successful. Specifically, patent application 2002/0184052 to Parker proposes an elective organization of selected doctors for providing medical services to organization members. The '052 proposal, however, provides no method or structure for lowering the overall cost of primary healthcare by not utilizing primary care health insurance. In fact, an object of the '052 patent application is merely to increase the number of locations at which a member may obtain medical services and that the organization still honors whatever medical insurance the member already has. Further, the '052 patent does not teach a method for dramatically reducing the cost to clinics of providing medical services or dramatically decreasing the cost to patient members. The '052 certainly does not suggest such cost savings as a result of avoiding the traditional primary care health insurance system.

Therefore, it is desirable to have an method and electronic information management system for establishing and managing a member based health clinic program that does not utilize or involve primary medical insurance, reduces the cost to both clinics and patients, and establishes more efficient provision of primary medical services. The present method and system clearly produces the tangible results of increased profits to health clinics through reduced staffing and insurance premium avoidance as well as a literal or effective increased compensation to clinic employees.

### SUMMARY OF THE INVENTION

A method and system for providing and managing a membership-based health care program without utilizing or involving primary care medical insurance includes providing a health care clinic to administer the program and providing an electronic information system to manage member records and to determine eligibility for services. The clinic employs at least one doctor and a plurality of other clinic employees to provide primary medical services to members of the program.

In a broad aspect of the invention, the membership program of the present invention dramatically reduces the cost of health care, both to the doctor or clinic and to the patient, by no longer utilizing primary care insurance. This enables the clinic to reduce staff previously needed for processing insurance claims to multiple insurers, thus increasing the clinic's bottom line. Further, the previous high cost of the clinic's overhead no longer needs to be passed along to the patient and insurer.

The present invention also proposes a membership based program in which members enter into a purchase arrangement with the clinic for level monthly payments in order to obtain a predetermined comprehensive set of medical services, such as unlimited office visits, labs, x-rays, and other in-clinic procedures. The level payments may be lower than traditional insurance premiums due to the cost savings to the clinic described above. Therefore, the cost of healthcare both to the clinic and patient members is dramatically reduced. This methodology also has the tangible effect of increasing the overall compensation to clinic employees, either literally or effectively.

Another aspect of the inventive methodology involves an electronic information management system (“IMS”) having a central processing unit (“CPU”) connected to an electronic database. The database includes a plurality of member records with each record including at least a member identifier and a purchase arrangement data field. The IMS and database are used to analyze and indicate when services are authorized to be rendered.

Still another aspect of the present method and system allows even greater cost savings to be realized by the clinic itself. Specifically, the clinic may waive membership purchase arrangements to its own employees and provide the medical services as an employment benefit. As the clinic's own doctors and staff perform the medical services, the cost of providing healthcare to its employees is less expensive than paying traditional insurance premiums. Again, this presents a large savings to both the clinic and to its employees. As will be described in greater detail later, a medium to large sized company may actually own its own clinic and treat its employees like the clinic's employees so as to eliminate the need for third party insurance and to experience dramatic cost savings.

It should be appreciated that all of these steps are electronically managed by the corresponding information management system. Specifically, the information management system manages the treatment of clinic employee members, owner company employee members, outside/non-employee members, and the purchase arrangements of each. In fact, it is contemplated that a network organization utilizing the information management system may centrally manage a plurality of clinics using wide-area network connections.

Therefore, a general object of this invention is to provide a method and system for providing and managing a membership based clinic healthcare program that does not utilize primary care insurance.

Another object of this invention is to provide a method and system, as aforesaid, which reduces the cost of primary healthcare for both health clinic providers and member healthcare recipients.

Still another object of this invention is to provide a method and system, as aforesaid, which increases cash flow to a health clinic while reducing paperwork.

Yet another object of this invention is to provide a method and system, as aforesaid, which completely removes the bureaucratic health insurance industry from primary healthcare.

A further object of this invention is to provide a method and system, as aforesaid, which manages a healthcare system with an electronic information management system.

A still further object of this invention is to provide a method and system, as aforesaid, which provides dramatic cost savings to a health clinic and its employees by eliminating payment of primary care insurance premiums by either.

A particular object of this invention is to provide a method and system, as aforesaid, for electronically managing ownership of a membership-based health clinic by a medium to large sized company otherwise unrelated to healthcare services.

Another object of this invention is to provide a method and system, as aforesaid, that notifies members about catastrophic and hospitalization insurance.

Other objects and advantages of this invention will become apparent from the following description taken in connection with the accompanying drawings, wherein is set forth by way of illustration and example, embodiments of this invention.

### BRIEF DESCRIPTION OF THE DRAWINGS

FIG. 1 is a block diagram illustrating a system and method for administering a membership based healthcare program according to one embodiment of the present invention;

FIG. 2 is a block diagram illustrating an aspect of the method and system as in FIG. 1 where the clinic is itself owned and controlled by a company not otherwise associated with healthcare;

FIG. 3 is a schematic diagram illustrating a member record stored in a database of an information management system managing the healthcare program as in FIG. 1;

FIG. 4 is a flowchart showing the logic performed by the information management system according to the invention as in FIG. 1;

FIG. 5 is a block diagram illustrating a system and method for administering a membership based healthcare program according to another embodiment of the present invention; and

FIG. 6 is a flowchart illustrating the logic of an enrollment process according to the system and method of FIG. 1.

### DESCRIPTION OF THE PREFERRED EMBODIMENT

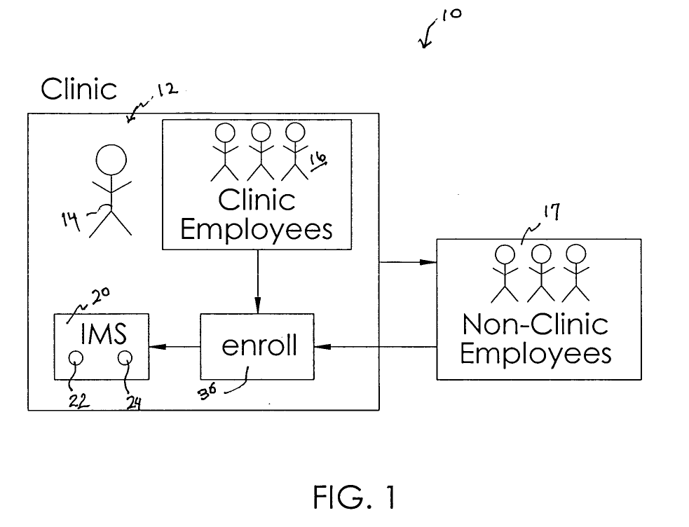

An electronically-implemented method and system for administering and managing a membership-based clinic healthcare program that does not utilize or involve primary healthcare insurance will now be described in detail with reference to FIGS. 1 through 6 of the accompanying drawings.

According to a now preferred embodiment of the present method and system 10, a health clinic 12 is established or selected to administer a membership-based healthcare program (FIG. 1). The healthcare program does not utilize or participate in any primary care insurance plan. In other words, the clinic 12, according to the program, does not submit insurance claims or receive money paid on claims by a primary care insurance carrier. The clinic 12 established or chosen to administer and manage the healthcare program preferably employs at least one doctor 14 and a plurality of clinic support employees 14, such as nurses, lab technicians, physicians' assistants, and the like for providing medical services.

According to the preferred method, the healthcare program is limited to members of the program and therefore requires new members to become enrolled, as will be described in more detail below. Enrolled members who complete enrollment procedures, which may or may not include payment of fees, are eligible to receive a predetermined set of medical services, including, but not limited to, unlimited office visits, labs, x-rays, and other in-clinic procedures. Medical care related to workman's compensation may also be included in membership. Supplemental catastrophic/hospitalization insurance is recommended to program members to cover services not provided by the program.

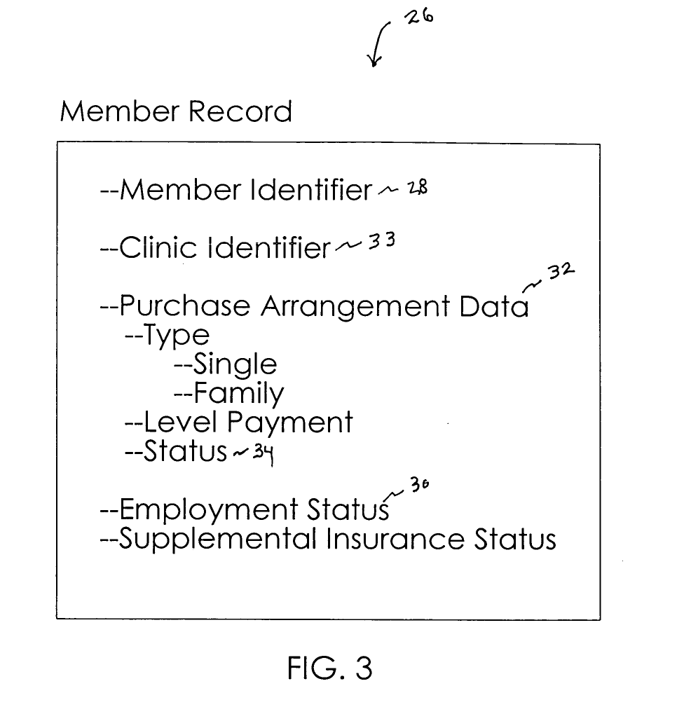

The present method and system 10 further includes an information management system (“IMS”) 20 having a central processing unit (“CPU”) 22 electrically connected to a database 24. The database 24 includes a plurality of member records 26, each member record having data fields associated with a member identifier 28, employment status 30, and purchase arrangement 32 data, as to be more discussed more fully later. As shown in FIG. 3, other data fields may also be included in each member record 26.

The purchase arrangement for each member is predetermined by the clinic 12 and includes a level payment component such as a monthly membership fee. The structure of the purchase arrangement may include single or family plan arrangements or some other arrangement determined by the clinic 12. The details of the purchase arrangement, including payment status 34, are stored in respective member records 26 of the database 24 (FIG. 3).

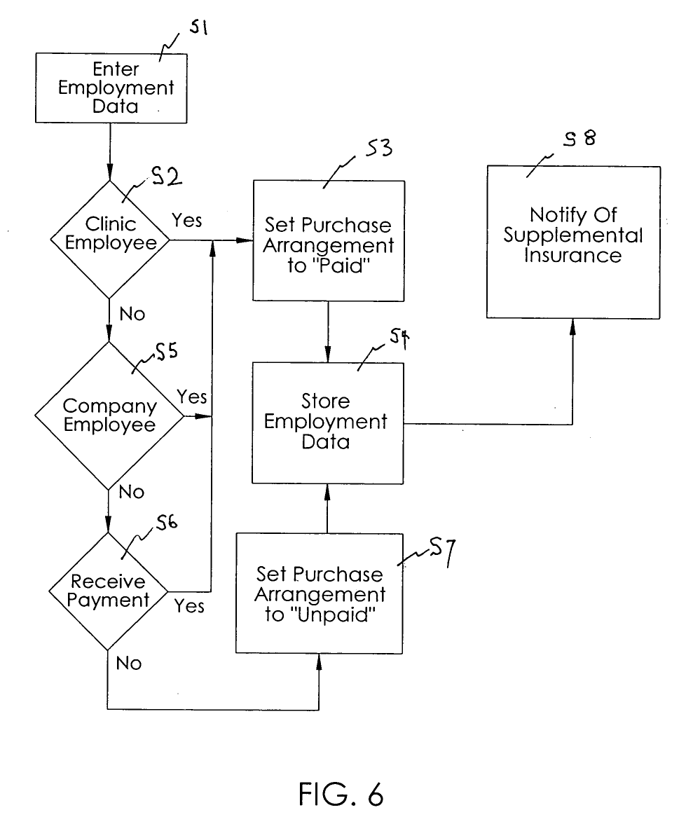

All persons who desire to participate in the clinic healthcare program must go through an enrollment process 36 (FIG. 6). It is understood that enrollment 36 may be completely performed via a computer network connection between the IMS 20 and potential member's personal computer, or with assistance of a clinic employee making use of the IMS 20. Member records 26 associated with all members are updated to reflect a purchase arrangement or status of an enrollment transaction and whether or not the initial level payment fee has been satisfied. Enrollment 36 of all members will be described in more detail later.

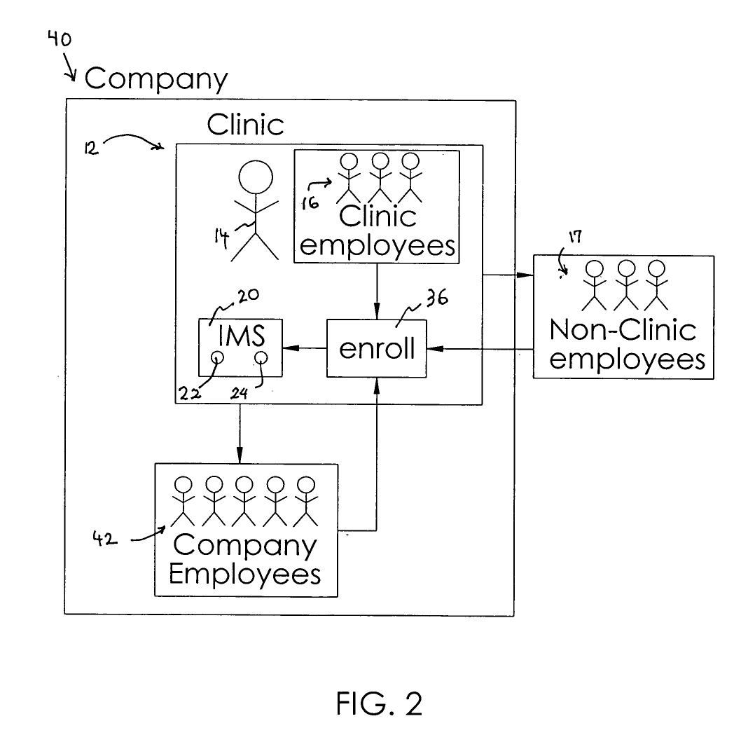

Before discussing enrollment 36, however, another aspect of the present invention is shown in FIG. 2. According to this aspect, a company 40 may own and control the clinic 10, the company 40 being otherwise unrelated or not directly associated with providing primary healthcare. For reasons that will become evident below, the company 40 employs a plurality of company employees 42 who will become enrolled members of the program.

Now, the enrollment 36 of new members may be described relative to the method and system shown in FIGS. 1 and 2. FIG. 6 illustrates the logic performed by the CPU 22 in an enrollment transaction between a potential new member and the clinic 12. Specifically, the CPU 22, aided or unaided by a clinic employee, solicits employment data from the potential member at process step S1. The CPU 22, at process step S2, asks if the new member is an employee of the clinic 12. If so, the purchase arrangement field of a respective new member record is set to indicate “paid” fees at process step S3 and the employment data is also stored at process step S4.

If not a clinic employee 16, the CPU 22, at process step S5, determines if the new member is an employee of an owner company 40. If so, the purchase arrangement field of a respective new member record is set to indicate “paid” fees at process step S3 and the employment data is also stored at process step S4. In this case, owner company employees 42 are classified and treated the same as clinic employees 16, i.e. all purchase arrangement fees are automatically considered to be “paid” even though neither the clinic 12, owner company 40, nor employees actually paid them. Alternatively, the owner company 40 may actually pay the fees to the clinic 12 which, since the clinic 12 is owned by the company, is like paying itself. This payment may be made by electronic funds transfer or through electronic accounting means since the clinic is owned by the company. Of course, a company may choose to only pay part of the enrollment of each employee and, in that case, only the predetermined percentage would be forwarded.

The doctor 14 and clinic employees 16 provide the needed primary care medical services automatically and both insurance premiums and insurance inefficiencies are eliminated. It should also be appreciated that the enrollment transaction also includes agreement between the clinic and member that regular level payments must continue to made in order for medical services to be rendered. In the company-owned clinic scenario, it should be appreciated that money that would otherwise be paid to a third party insurance carrier is kept within the company's own financial system and provides greater control over costs.

Further to member enrollment 36, if a new member is neither a clinic employee or owner company employee, as determined at process step S6 the CPU 22 automatically deduces that the new member must be a non-employee of the clinic 12 or owner company 40 and automatically sets the purchase arrangement data field to “unpaid fees” at process step S7 and stores the employment data at S4 (FIG. 6).

As indicated by process step S8, the CPU 22 directs that a notice be given, either electronically or by a clinic employee, regarding the existence of supplemental catastrophic or hospitalization insurance.

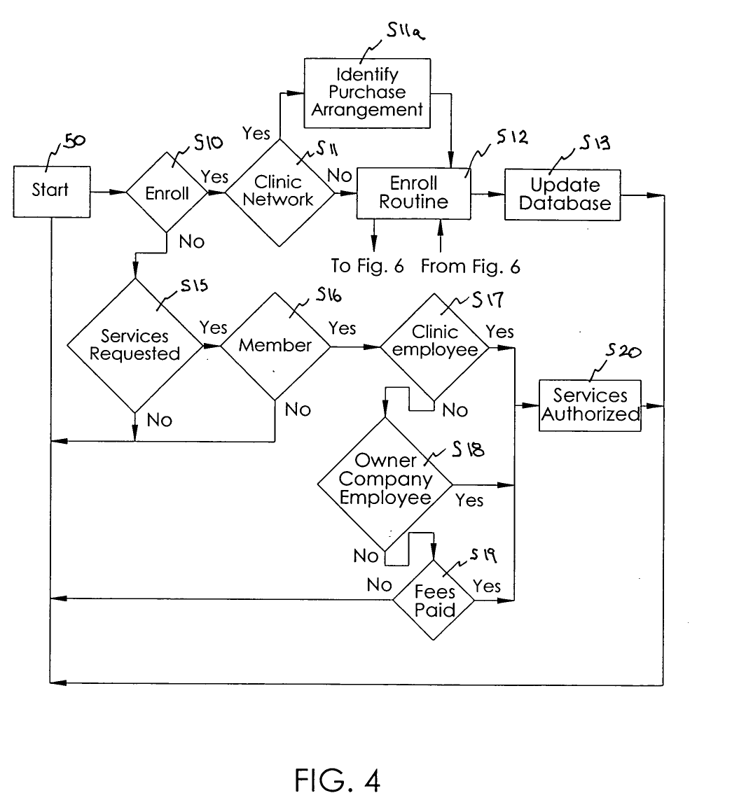

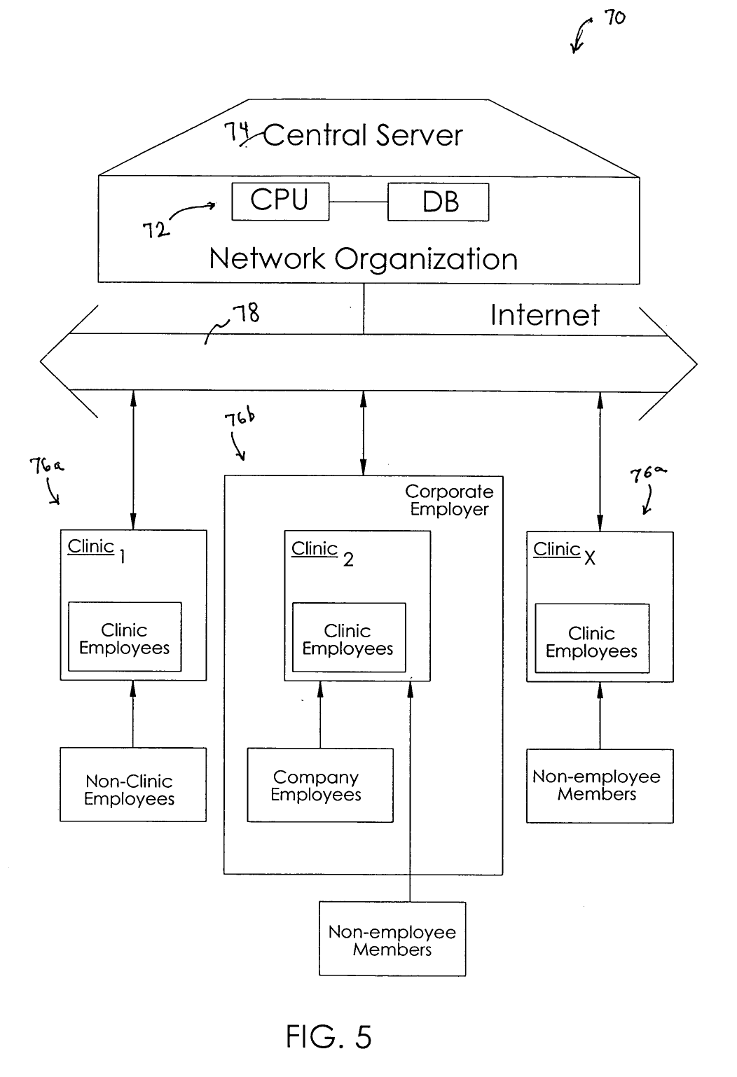

The logic of the CPU 22 for operation of electronically implemented method and system is illustrated in FIG. 4. More particularly, the CPU 22 determines at process step S10 if a new member enrollment is desired. If so, the CPU 22 proceeds to step S11 to determine if a clinic network is implemented, clinic networks being more fully described later with reference to FIG. 5. In any case, the CPU 22 proceeds to manage the enrollment process as indicated by step S12 and as previously described with reference to FIG. 6. Following enrollment 36, the database 24 is updated at step S13 and control is returned to the start 50 of the method operation.

If enrollment is not desired, then the CPU 22 proceeds at process step S15 to determine if medical services are being requested. If so, then it is determined at step S16 if the requester is a member. If not, control is returned to the start 50 of the method. Otherwise, the CPU 22 queries the database 24 to determine if the member is a clinic employee, owning company employee, or non-employee member who has paid membership fees, as indicated by steps S17 to S19. If any of these cases is affirmative, then the CPU 22 indicates that medical services may be rendered S20 and, presumably, such services are in fact rendered to qualified members.

A method and system 70 for providing and managing a membership based healthcare program according to another embodiment of the present invention is shown as a block diagram in FIG. 5. The method and system according to this embodiment is substantially similar to the method and system previously described except as specifically noted below. Specifically, an information management system 72 is located at a central healthcare network organization or central server 74 and electronically connected to a plurality of clinics 76a, 76b using a wide-area computer network 78 such as the Internet. Therefore, this embodiment of the system allows electronic management of the plurality of clinics 76a, 76b operating in a manner substantially similar to the method and system first described.

Each member record 26 may include a clinic identifier field 33 as well (FIG. 3) to facilitate electronic management of multiple clinics. The information management system 72 also makes use of this information during the enrollment process. If the CPU 22 determines that a multiple clinic arrangement is being utilized, as indicated at step S11 of FIG. 4, then control proceeds to step S11a and a predetermined purchase arrangement specific to an identified clinic is utilized in enrollment 36.

As illustrated, this embodiment of the system 70 allows management of clinics 76a that only service its own employees without utilizing medical insurance, e.g. merely as a company healthcare benefit, or management of clinics 76b owned and controlled by a larger company, e.g. to provide medical services to its employees. And, of course, each clinic 12 may also provide services to members 17 who are neither clinic employees 16 nor company employees 42. In all case, medical services may be provided without utilizing traditional primary care insurance.

It should be remembered that the present method does not utilize primary health care insurance and, therefore, does not require the personnel (and cost) necessary to process insurance claims. Operation of the disclosed method and illustration of the tangible results produced are even better illustrated by an example. The example health clinic operating, according to the disclosed methodology would include 1,000 annual health care purchase plans, providing health care services to individuals and families. The ratio of family and individual plan enrollees would be fifty-percent (50%) each. The example health care clinic would provide primary health care services to enrollees whether employees of an industry or a business-owned clinic or individual/family-community enrollees. A clinic of this size, operating seven (7) days a week, could provide an average of twenty-five (25) office visits per day. Specifically, an individual purchase arrangement may include an approximate eighty-three dollar ($83.00) per month fee and a family purchase arrangement may include about a one-hundred twenty-five dollar ($125.00) per month fee.

The clinic, applying the present method, could generate over one million dollars ($1,000,000.00) annually in revenue and be self-funded. When combined with optional hospitalization, dental, or optical insurance plans offered by another entity, this represents a cost savings of about thirty percent (30%) regardless of the number of enrollees per community-based clinic and a fifty percent (50%) savings to an industry or business-owned clinic when compared to the traditional insurance-based models. The increased savings for the employers and clinics is primarily due to direct healthcare service being provided without necessary payment by the employer of health insurance premiums or payment to a third-party healthcare provider.

An industry or business-owned clinic reaps further dividends when considering the current high costs of Workers' Compensation benefits and claims. Specifically, an industry or business saves significantly by sending its injured workers to its own clinic. As described above, primary health care services are provided directly by the self-owned clinic, without payments of insurance premiums or payment to third-party healthcare providers. Further, the industry or business has total control over the healthcare costs related to clinic services provided to the injured employees.

It should also be appreciated that a major tangible result of the disclosed method is that members, clinic employees, and owner company employees receive increased compensation. Specifically, these employees may receive higher actual compensation from their employers as a result of the employer's dramatic cost savings, or they receive indirect compensation by not having to pay insurance premiums or claim deductibles.

Accordingly, this system for administering a membership-based health care system not utilizing primary care insurance, whether involving only a single clinic, company-owned clinic, or network of clinics communicating via the Internet, dramatically decreases the cost of health care both to clinics and patients. Further, the computer implementation of the present method provides an important aspect of efficient operation that further lower the cost of health care which provides greater compensation to patients.

Having thus described the invention, what is claimed as new and desired to be secured by Letters Patent is as follows:

1. An electronically-implemented method for providing and managing a membership healthcare program not utilizing primary care insurance, said method comprising the steps of:
providing a health care clinic for administering the membership health care program, said clinic employing at least one doctor and a plurality of clinic employees for providing medical services to members of the program without utilizing primary care medical insurance;
providing an electronic database having a plurality of member records, each member record having a member identifier and a purchase arrangement data field;
enrolling new members into the program by transacting a predetermined purchase arrangement between said new members and said clinic, said step of enrolling new members including receiving a predetermined fee and establishing a schedule of level-pay fees;
storing a respective member identifier and purchase arrangement data in a respective member record for each enrolled member; and
rendering said medical services to a respective enrolled member when a corresponding purchase arrangement data field is indicative of paid fees, whereby said medical services are provided at a cost to said clinic and said members that is comparatively lower than a cost thereto when utilizing primary care health insurance.

2. The method as in claim 1 wherein each member record includes an employment data field, said method further including the steps of:
determining during enrollment whether a prospective member is employed by said clinic;
storing employment status data in a corresponding employment data field of a corresponding member record associated with said prospective member; and
if said prospective member is employed by said clinic, waiving all fees associated with said purchase arrangement and automatically setting said purchase arrangement data field associated with said prospective member to indicate paid fees.

3. The method as in claim 2 further comprising the step of proceeding with said step of rendering said medical services to a respective member if a corresponding employment data field associated with said respective member is indicative that said respective member is not employed by said clinic but that a corresponding purchase arrangement data field associated with said respective member is indicative of paid fees.

4. The method as in claim 1 wherein said medical services include primary care medical services, unlimited office visits, labs, x-ray, and predetermined in-clinic procedures.

5. The method as in claim 1 wherein said purchase arrangement includes predetermined individual and family level-pay fee arrangements.

6. The method as in claim 1 wherein said method includes notifying said members regarding availability of supplemental catastrophic and hospitalization insurance.

7. The method as in claim 1 wherein:
said clinic is owned by a company not otherwise associated with health care and having a plurality of company employees;
said method further comprising the step of automatically setting respective purchase arrangement data fields of respective member records associated with said company employees to indicate paid fees.

8. The method as in claim 7 further comprising the step of said company paying to said clinic all fees associated with respective purchase arrangements of said company employees; and
wherein said step of enrolling new members includes electronically receiving enrollment data through a computer network.

9. The method as in claim 8 wherein said step of paying said respective fees includes paying said respective fees by electronic funds transfer.

10. The method as in claim 2 wherein:
said clinic is owned by a company not otherwise associated with health care and having a plurality of company employees; and
said plurality of clinic employees of said clinic includes said company employees, wherein respective employment data fields of respective member records associated with said company employees are set to indicate employment by said clinic such that all purchase arrangement fees are waived.

11. A system for managing a membership healthcare program not utilizing primary care insurance, comprising:
an electronic information management system having a central processing unit (“CPU”) and a database electrically connected to said CPU, said database having a plurality of member records, each member record having a member identifier and a purchase arrangement data field;
a health clinic for utilizing said information management system to administer the program, said clinic employing at least one doctor and a plurality of clinic employees for providing a predetermined set of medical services to a plurality of members of the program, said clinic establishing a purchase arrangement by which said medical services may be obtained by said members;
means for enrolling a new member into the program by transacting said purchase arrangement between said clinic and said new member, said means for enrolling said new member including means for receiving payment of a predetermined fee and establishing a schedule of level-pay fees;
means in said CPU for storing a respective member identifier and purchase arrangement in a respective member record of said database for each enrolled member;
wherein said doctor is authorized to render said medical services to a respective member when a corresponding purchase arrangement data field associated with said respective member is indicative of paid fees, whereby said medical services are rendered at reduced cost to said members and said clinic by not utilizing primary care insurance.

12. The system as in claim 11 wherein said enrolling means includes means for electronically transacting said purchase arrangement and means for electronically receiving payment of said predetermined fees.

13. The system as in claim 11 further comprising means in said CPU for setting respective purchase arrangement data fields associated with said clinic employees to indicate paid fees, wherein said medical services are provided to said clinic employees as an employee benefit.

14. The system as in claim 11 wherein:
said health clinic is owned by a company not otherwise associated with health care and having a plurality of company employees;
said system further comprising means in said CPU for setting respective purchase arrangement data fields of respective member records associated with said company employees to indicate paid fees, whereby membership in the program is given to said company employees as a company employee benefit.

15. The system as in claim 14 further comprising means in said CPU for electronically receiving funds from said company corresponding to purchase arrangement fees associated with said company employees, whereby said company pays said purchase arrangement fees to said clinic.

16. The system as in claim 11 wherein:
said health clinic is a network of health clinics employing a plurality of network doctors and a plurality of network employees;
said information management system is electrically connected to a wide-area network for electronic communication between said network of health clinics, said database including respective member records corresponding to said network of health clinics.

17. The system as in claim 16 wherein each member record includes a clinic identifier for identifying a respective clinic is associated with a respective member.
